(19) United States
(12) Patent Application Publication
(10) Pub. No.: US 2025/0178819 A1
(43) Pub. Date: Jun. 5, 2025

(54) INSULATED CONTAINERS WITH VIEWING WINDOW

(71) Applicant: Elise Feibush, Philadelphia, PA (US)

(72) Inventor: Elise Feibush, Philadelphia, PA (US)

(21) Appl. No.: 18/968,721

(22) Filed: Dec. 4, 2024

Related U.S. Application Data
(60) Provisional application No. 63/606,123, filed on Dec. 5, 2023.

(51) Int. Cl. B65D 81/38; B65D 25/56; B65D 41/04; G01F 23/02

(52) U.S. Cl. CPC B65D 81/3841; B65D 25/56; B65D 41/04; B65D 81/3839; G01F 23/02

(57) ABSTRACT

In some embodiments, an insulated container may include a top portion and a bottom portion. The insulated container may include an inner wall extending from the top portion to the bottom portion. The insulated container may include an outer wall extending from the top portion to the bottom portion. The inner wall and the outer wall may be coupled together and may define a space between them. The inner wall and the outer wall may define an aperture. The insulated container may include a viewing window disposed within the aperture. The insulated container may include a cap coupled to the top portion.

### CROSS-REFERENCE TO RELATED APPLICATIONS

This application claims the benefit of priority under 35 U.S.C. § 119 (e) to prior U.S. Provisional Patent Application No. 63/606,123 filed on Dec. 5, 2023, the disclosure of which is incorporated by reference herein in its entirety.

### FIELD OF DISCLOSURE

The disclosed apparatuses relate to containers. More particularly, the disclosed apparatuses are directed to insulated beverage containers.

### BACKGROUND

Conventional insulated beverage containers, such as double walled vacuum insulated stainless steel water bottles, allow fluid in the container to maintain a desired temperature for longer than conventional beverage containers. However, these insulated water bottles are opaque and double walled throughout, which prevents a user from observing the level of the fluid within the container. As such, there is a need for insulated beverage containers that allow a user to see through the container to determine the level of fluid held in the container.

### SUMMARY

In some embodiments, an insulated container may include a top portion and a bottom portion. The insulated container may include an inner wall extending from the top portion to the bottom portion. The insulated container may include an outer wall extending from the top portion to the bottom portion. The inner wall and the outer wall may be coupled together and may define a space between them. The inner wall and the outer wall may define an aperture. The insulated container may include a viewing window disposed within the aperture. The insulated container may include a cap coupled to the top portion.

In some embodiments, the inner wall and the outer wall may be formed or welded together. In some embodiments, the space between the inner wall and the outer wall may be filled with one of a gas, air, or an insulating foam. In some embodiments, the space between the inner wall and the outer wall may be at a vacuum. In some embodiments, the inner wall and the outer wall may form a double-wall vacuum insulated metal container. In some embodiments, the inner wall and the outer wall may be formed of stainless steel. In some embodiments, the viewing window may include a plurality of markers.

In some embodiments, an insulated container may include a top portion and a bottom portion. The insulated container may include an inner wall extending from the top portion to the bottom portion. The insulated container may include an outer wall extending from the top portion to the bottom portion. The inner wall and the outer wall may be coupled together and may define a space between them. The inner wall and the outer wall may define an aperture. The insulated container may include a viewing window disposed within the aperture and may be coupled to the insulated container. The insulated container may include a cap coupled to the top portion.

In some embodiments, the inner wall and the outer wall may be formed or welded together. In some embodiments, the space between the inner wall and the outer wall may be filled with one of a gas, air, or an insulating foam. In some embodiments, the space between the inner wall and the outer wall may be at a vacuum. In some embodiments, the inner wall and the outer wall may form a double-wall vacuum insulated metal container. In some embodiments, the inner wall and the outer wall may be formed of stainless steel. In some embodiments, the viewing window may include a plurality of markers.

In some embodiments, an insulated container may include a top portion and a bottom portion. The insulated container may include an inner wall extending from the top portion to the bottom portion. The insulated container may include an outer wall extending from the top portion to the bottom portion. The inner wall and the outer wall may be coupled together and may define a sealed space between them. The inner wall and the outer wall may define an aperture. The insulated container may include an outer shell coupled to the outer wall. The insulated container may include an inner shell coupled to the inner wall. A viewing window may be formed through the outer shell, the aperture, and the inner shell. The insulated container may include a cap coupled to the top portion.

In some embodiments, the inner wall and the outer wall may be formed or welded together. In some embodiments, the space between the inner wall and the outer wall may be filled with one of a gas, air, or an insulating foam. In some embodiments, the space between the inner wall and the outer wall may be at a vacuum. In some embodiments, the inner wall and the outer wall may form a double-wall vacuum insulated metal container. In some embodiments, the inner wall and the outer wall may be formed of stainless steel.

### BRIEF DESCRIPTION OF THE DRAWINGS

The features and advantages of the present disclosure will be more fully disclosed in, or rendered obvious by, the following detailed descriptions of example embodiments. The detailed descriptions of the example embodiments are to be considered together with the accompanying drawings wherein like numbers refer to like parts and further wherein:

FIG. 1A illustrates an exploded view of a first exemplary insulated container having a viewing window in accordance with some embodiments.

FIG. 1B illustrates an isometric view of a first exemplary insulated container having a viewing window in accordance with some embodiments.

FIG. 1C illustrates a front view of a first exemplary insulated container having a viewing window in accordance with some embodiments.

FIG. 1D illustrates an isometric view of a first exemplary insulated container having a viewing window in accordance with some embodiments.

FIG. 1E illustrates a top view of a first exemplary insulated container having a viewing window in accordance with some embodiments.

FIG. 1F illustrates a bottom view of a first exemplary insulated container having a viewing window in accordance with some embodiments.

FIG. 1G illustrates a cross-sectional view of a first exemplary insulated container having a viewing window along axis A-A illustrated in FIG. 1E in accordance with some embodiments.

FIG. 1H illustrates a partial cross-sectional view of a first exemplary insulated container cap along detail B illustrated in FIG. 1G in accordance with some embodiments.

FIG. 2A illustrates an isometric view of a second exemplary insulated container having a viewing window in accordance with some embodiments.

FIG. 2B illustrates an isometric view of a second exemplary insulated container having a viewing window in accordance with some embodiments.

FIG. 2C illustrates an isometric view of a second exemplary insulated container with an inner shell and an outer shell removed in accordance with some embodiments.

FIG. 2D illustrates a front view of a second exemplary insulated container having a viewing window in accordance with some embodiments.

FIG. 2E illustrates an isometric view of a second exemplary insulated container having a viewing window in accordance with some embodiments.

FIG. 2F illustrates a top view of a second exemplary insulated container having a viewing window in accordance with some embodiments.

FIG. 2G illustrates a bottom view a second exemplary insulated container having a viewing window in accordance with some embodiments.

FIG. 2H illustrates a cross-sectional view of a second exemplary insulated container having a viewing window along axis A-A illustrated in FIG. 2F in accordance with some embodiments.

FIG. 21 illustrates a partial cross-sectional view of a second exemplary insulated container cap along detail B illustrated in FIG. 2H in accordance with some embodiments.

FIG. 3 illustrates a front view of an exemplary insulated container having a viewing window with markers in accordance with some embodiments.

While the present disclosure is susceptible to various modifications and alternative forms, specific embodiments have been shown by way of example in the drawings and will be described in detail herein. It should be understood, however, that the present disclosure is not intended to be limited to the particular forms disclosed. Rather, the present disclosure is to cover all modifications, equivalents, and alternatives falling within the spirit and scope of the disclosure as defined by the appended claims.

### DETAILED DESCRIPTION

This description of the exemplary embodiments is intended to be read in connection with the accompanying drawings, which are to be considered part of the entire written description. It should be understood, however, that the present disclosure is not intended to be limited to the particular forms disclosed and that the drawings are not necessarily shown to scale. Rather, the present disclosure covers all modifications, equivalents, and alternatives that fall within the spirit and scope of these exemplary embodiments. In the description, relative terms such as “lower,” “upper,” “horizontal,” “vertical,” “above,” “below,” “up,” “down,” “top,” and “bottom” as well as derivatives thereof (e.g., “horizontally,” “downwardly,” “upwardly,” etc.) should be construed to refer to the orientation as then described or as shown in the drawing under discussion. These relative terms are for convenience of description and do not require that the apparatus be constructed or operated in a particular orientation. Terms concerning attachments, coupling and the like, such as “connected” and “interconnected” refer to a relationship wherein structures are secured or attached to one another either directly or indirectly through intervening structures, as well as both movable or rigid attachments or relationships, unless expressly described otherwise. The terms “couple,” “coupled,” “operatively coupled,” “operatively connected,” and the like should be broadly understood to refer to connecting devices or components together either mechanically, or otherwise, such that the connection allows the pertinent devices or components to operate with each other as intended by virtue of that relationship.

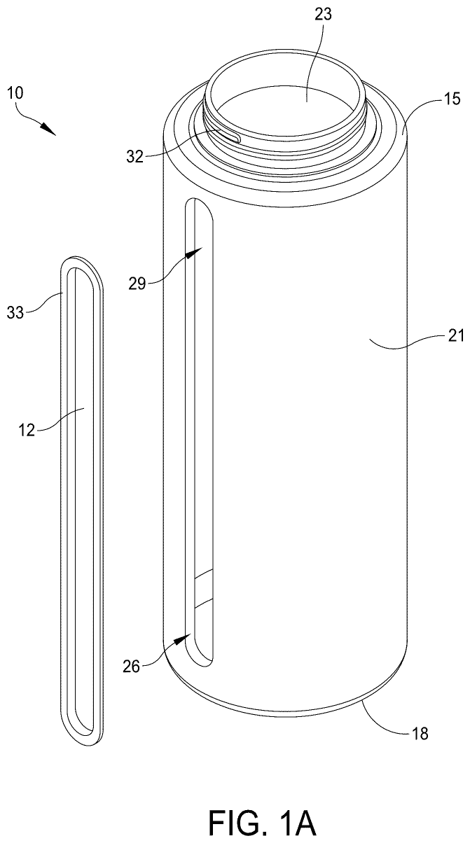

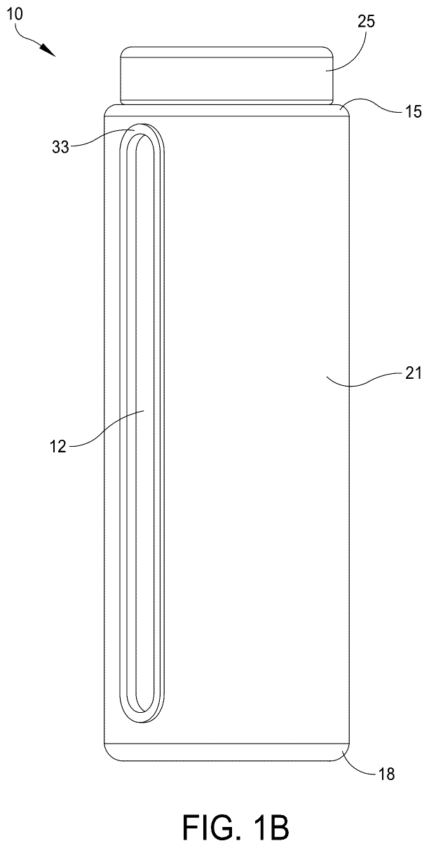

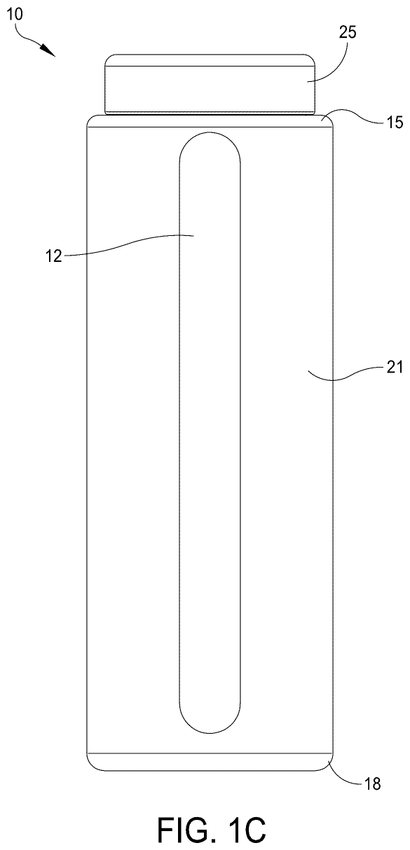

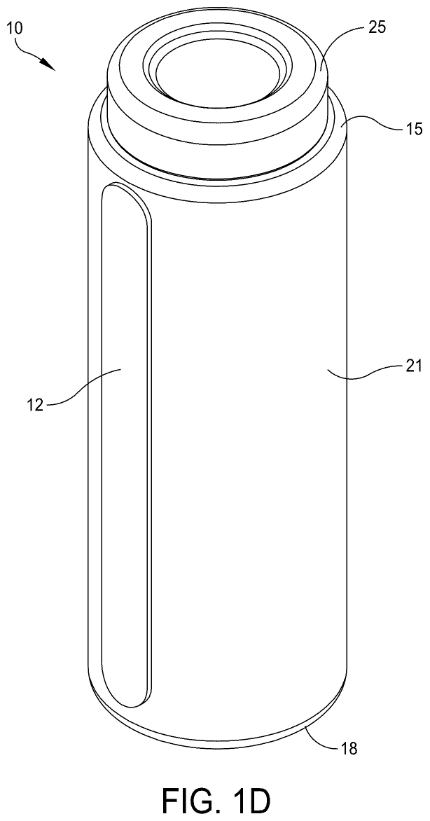

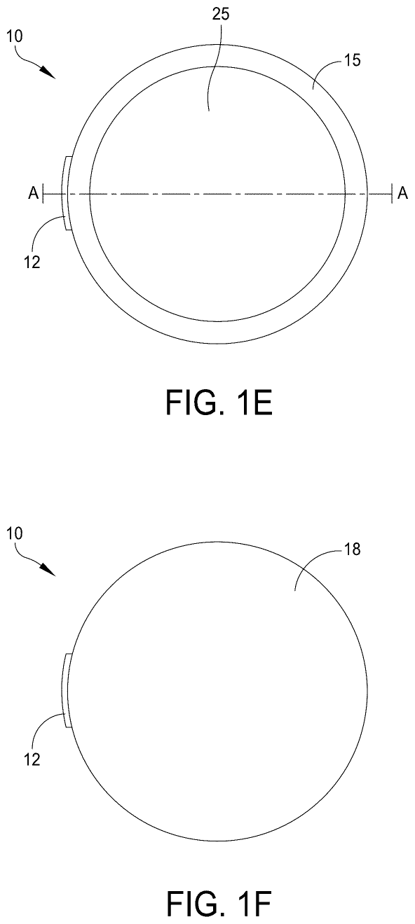

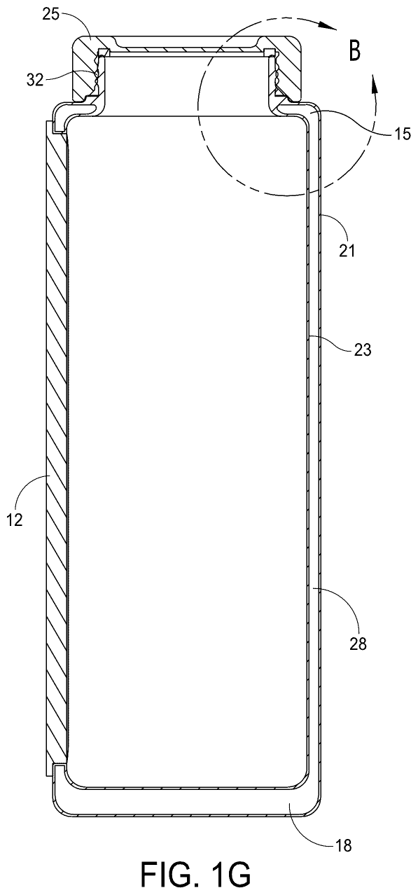

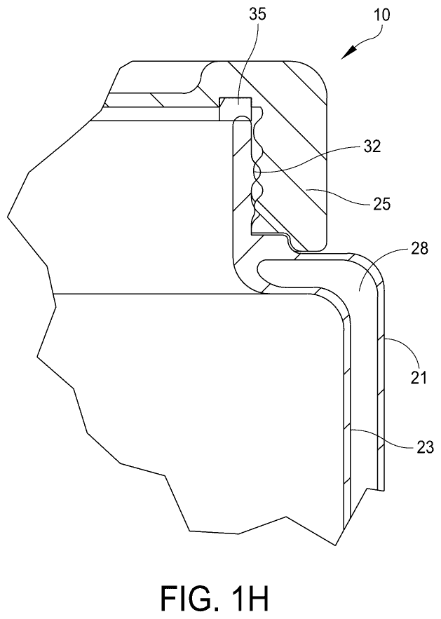

FIGS. 1A-1H illustrate a first exemplary insulated container 10 having a viewing window 12 in accordance with some embodiments. The insulated container 10 may include a viewing window 12, a top portion 15, a bottom portion 18, an outer wall 21, an inner wall 23, and a cap 25. The outer wall 21 and the inner wall 23 extend between the top portion 15 and the bottom portion 18 of the insulated container 10. The inner wall 23 and outer wall 21 are coupled together (i.e., formed together, welded together, etc.) to create side walls 26 such that a sealed space 28 is disposed between them as best illustrated in FIG. 1G. The space 28 may include a gas, air, insulating material (such as an insulating foam or other material), or be at a vacuum in order to provide insulation for a fluid contained by the insulated container 10. The coupling of the inner wall 23 and the outer wall 21 may also define an aperture 29 through the insulated container 10.

The insulated container 10 may be any one of a metal or plastic material to contain a fluid within the insulated container 10. However, in certain embodiments, the insulated container 10 may be a double-wall vacuum insulated metal container, such as formed from stainless steel material, configured to keep a fluid at a desired temperature, facilitated by the insulation from the space 28 separating inner wall 23 and outer wall 21. The insulated container 10 may also include threads 32 configured to be coupled with respective threads of the cap 25 in order to close the insulated container 10 to prevent spills of the fluid and to maintain a desired temperature for longer. It will be appreciated by a person of ordinary skill in the art that other forms of fastening a cap 25 to the insulated container 10 are possible.

The viewing window 12 may be configured to fit in the aperture 29 between the inner wall 23 and the outer wall 21. For example, the viewing window 12 may be configured to be press fit into the aperture 29 between the inner wall 23 and the outer wall 21 in some embodiments. In some embodiments, the viewing window 12 is secured in whole or part within aperture 29 to side walls 26 using an adhesive, or be melt bonded, sonically welded, or otherwise secured within the aperture 29. In other embodiments, the viewing window 12 may include a male or female coupling that is configured to couple to a respective female or male coupling on insulated container 10.

In some embodiments, the viewing window 12 may include a raised edge 33 disposed around the viewing window 12. The raised edge 33 disposed around the viewing window 12 may be configured to prevent the viewing window 12 from being pushed inside of the insulated container 10. For example, in the case of a viewing window 12 that is press fit into the aperture 29 formed between the inner wall 23 and the outer wall 21, if a user puts pressure on the viewing window 12 the raised edge 33 prevents the user from pushing the viewing window 12 into the insulated container 10. This further prevents inadvertent spills and possible damage to the viewing window 12 or the insulated container 10. The viewing window 12 may be any suitable transparent material such as glass, plastic, etc. Although the viewing window 12 is illustrated as raised up off the surface of the outer wall 21, it will be appreciated that the viewing window 12 may be configured to be flush or substantially flush with the outer wall 21.

FIG. 1G illustrates a cross-sectional view of a first exemplary insulated container 10 having a viewing window 12 along axis A-A illustrated in FIG. 1E in accordance with some embodiments. The viewing window 12 may be press fit into the aperture 29 interfacing with the side walls 26 in order to form a tight fit and prevent leaks from the edges of the viewing window 12. In some embodiments, the viewing window 12 may be insulated as well. For example, the viewing window 12 may also include an inner barrier and an outer barrier that are formed together to form a void configured to provide insulation, similar to inner wall 23, outer wall 21, and space 28. Although the viewing window 12 is illustrated as being substantially the same height as the insulated container 10, so as to allow for an accurate determination of the liquid level in the container 10, it will be appreciated that the insulated container 10 may be configured for a smaller viewing window 12 that does not extend the entire height of the insulated container 10 or a series of vertically spaced viewing windows located at different heights.

As further illustrated by FIG. 1G, the inner wall 23 and outer wall 21 are coupled together (or otherwise meet) forming side walls 26 such that space 28 is formed between them. In some embodiments, the inner wall 23 and the outer wall 21 extend around the majority of the insulated container 10 in a generally U-shape to provide an aperture 29 for the viewing window 12. As illustrated in FIG. 1G, the inner wall 23 and outer wall 21 also extend down to and create bottom portion 18. However, in some embodiments, the bottom portion 18 may be formed separate from the rest of the insulated container 10. For example, the inner wall 23 and outer wall 21 coupling may end before the bottom portion 18 of the insulated container 10. This may allow the bottom portion 18 of the insulated container 10 to be formed of a different material and/or include a weighted portion. As an example, the bottom portion 18 of the insulated container 10 may be formed as a solid piece (e.g., of rubber, plastic, or other suitable material) to provide adequate weight to prevent the insulated container 10 from tipping over.

FIG. 1H illustrates a partial cross-sectional view of a first exemplary insulated container cap 25 along detail B illustrated in FIG. 1G in accordance with some embodiments. As discussed above, the insulated container 10 may also include threads 32 that are configured to couple to respective threads on a cap 25 in order to prevent spills and maintain temperature. In some embodiments, the cap 25 may include a scal 35 (e.g., an O-ring) to prevent leaks when the insulated container 10 is turned over or on its side. Although the seal 35 is illustrated as disposed within the cap 25, it will be appreciated that the seal 35 may be disposed around the threads 32 of the insulated container 10.

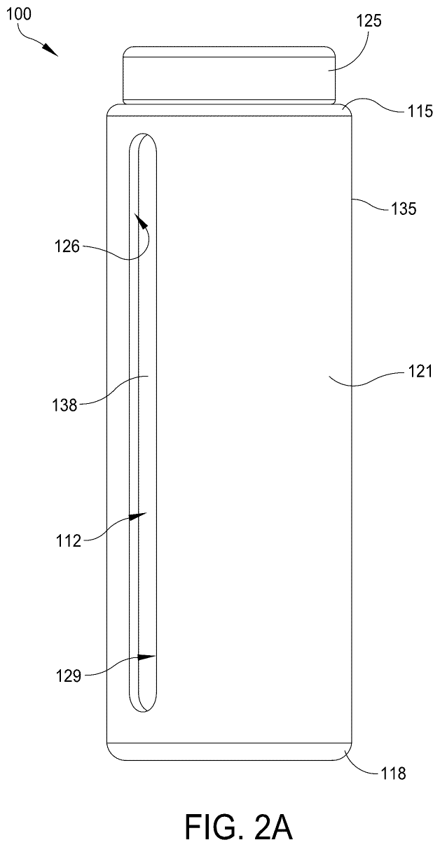

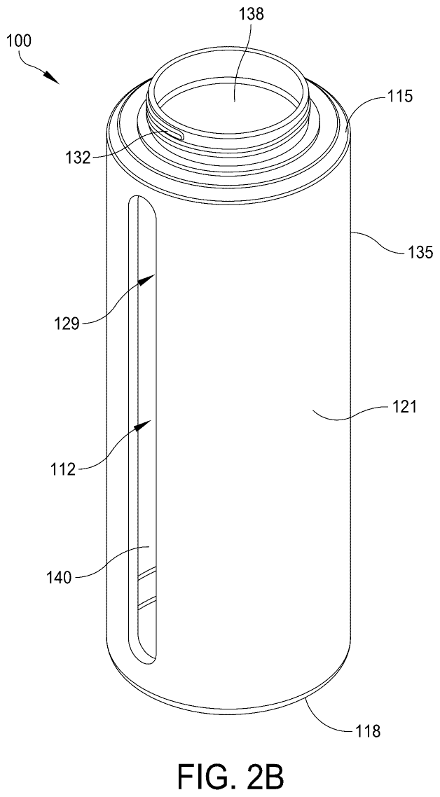

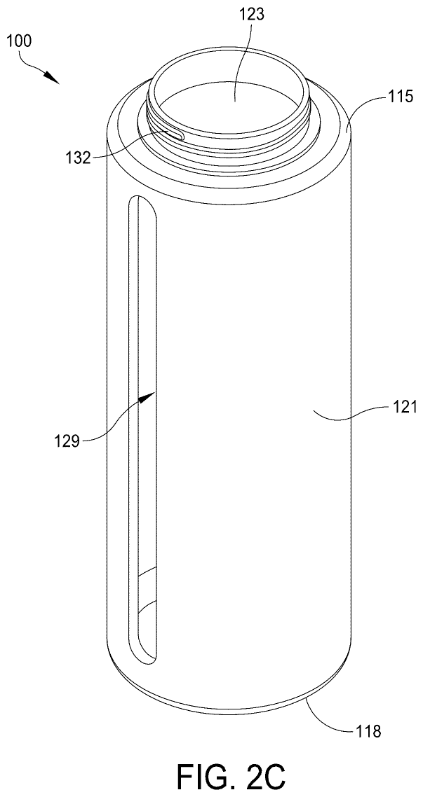

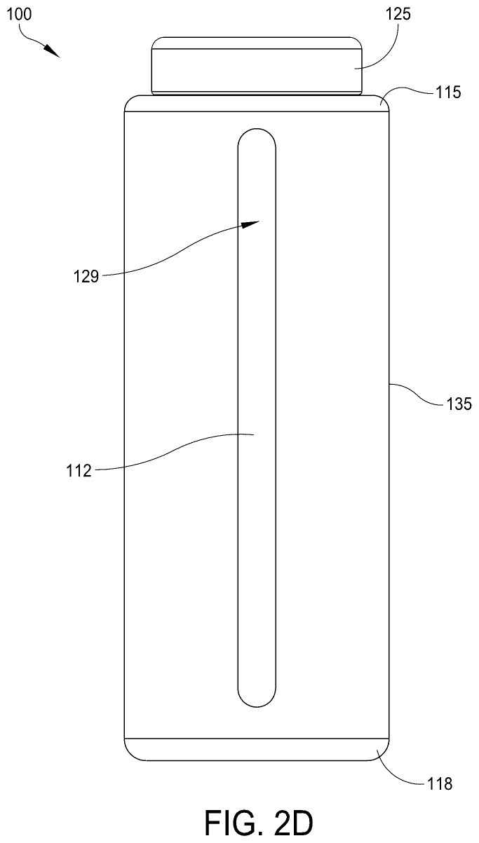

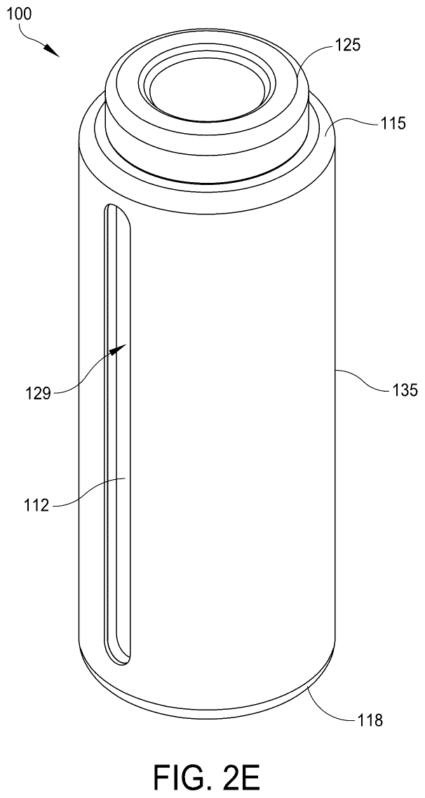

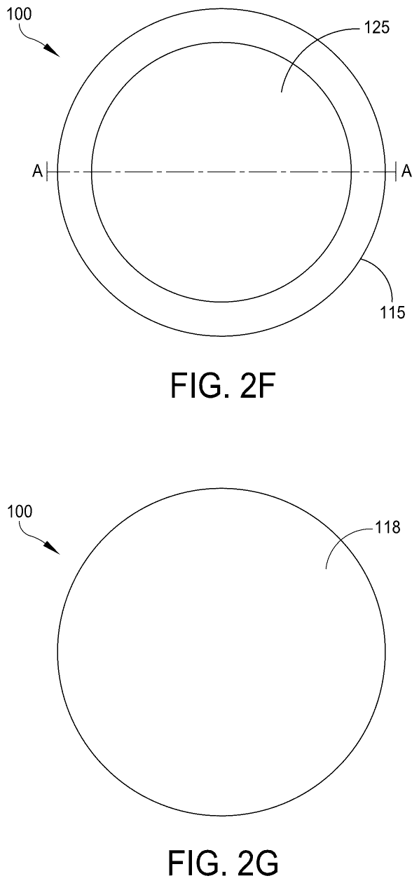

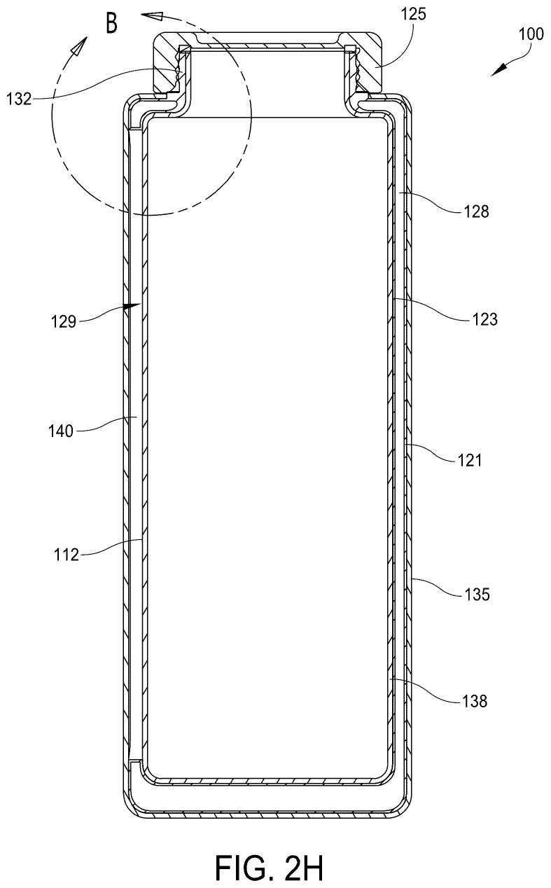

FIGS. 2A-21 illustrate a second exemplary insulated container 100 having a viewing window 112 in accordance with some embodiments. The insulated container 100 may have a top portion 115, a bottom portion 118, an outer wall 121, an inner wall 123, and a cap 125. The outer wall 121 and the inner wall 123 may extend between the top portion 115 and bottom portion 118 of the insulated container 100. The inner wall 123 and outer wall 121 are coupled together (i.e., formed together, welded together, etc.) to create side walls 126 such that a sealed space 128 is disposed between them. The space 128 may include a gas, an air, insulating material (such as insulating foam), or be at a vacuum in order to provide insulation for a fluid contained by the insulated container 100. The coupling of the inner wall 123 and the outer wall 121 also define an aperture 129 through the insulated container 100.

The insulated container 100 may be any one of metal or plastic material to contain a fluid within the insulated container 100. However, in certain embodiments, the insulated container 100 may be a stainless steel material configured to keep a fluid at a desired temperature, facilitated by the insulation from the space 128 separating inner wall 123 and outer wall 121. The insulated container 100 may also include threads 132 configured to be coupled with respective threads of the cap 125 in order to close the insulated container 100 to prevent spills of the fluid and to maintain a desired temperature for longer. It will be appreciated by a person of ordinary skill in the art that other forms of fastening a cap 125 to the insulated container 100 are possible.

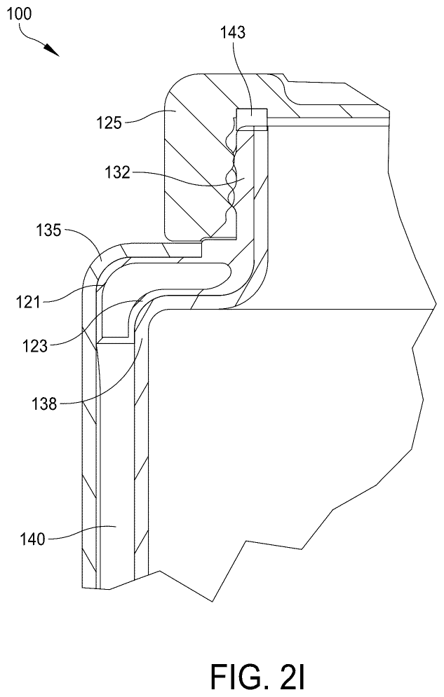

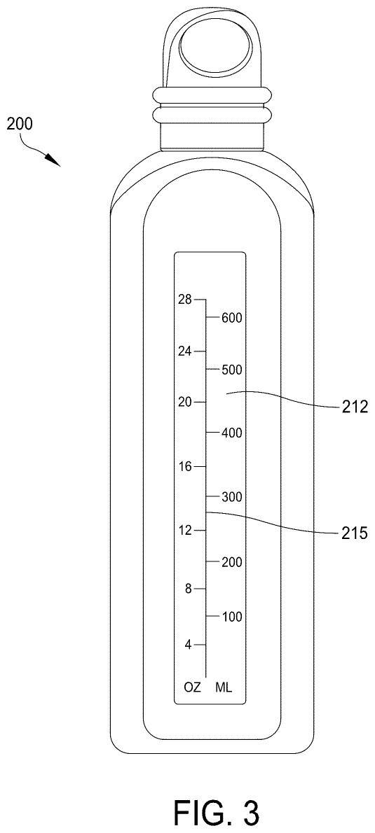

The viewing window 112 may be facilitated by an aperture 129 formed by the coupling of the inner wall 123 and the outer wall 121. In this embodiment, as best shown in FIGS. 21 and 2H discussed below, the container includes an exterior transparent wall (e.g., plastic, glass, or other suitable material) and an interior transparent wall (e.g., plastic, glass or other suitable material) between which the double-walled container is sandwiched. This design creates a viewing window 112 through the aperture 129 in the walls 121, 123, which may be insulated as well. For example, the insulated container 100 may also include a transparent outer shell 135 coupled to (e.g., compression fit, adhesive, male/female connections, etc.) the outer wall 121 and a transparent inner shell 138 coupled to (e.g., compression fit, adhesive, male/female connections, etc.) the inner wall 123. For example, the outer wall 121 may include a male or female connection that is configured to be coupled with a respective female or male connection on the outer shell 135. The inner wall 123 may also include a male or female connection that is configured to be coupled with a respective female or male connection on the inner shell 138. The outer shell 135 and the inner shell 138 may be any suitable transparent material, such as glass, plastic, etc., such that the outer shell 135 and the inner shell 138 form a viewing window 112 through the aperture 129 defined by the outer wall 121 and the inner wall 123. By using an outer shell 135 coupled to the outer wall 121 and an inner shell 138 coupled to the inner wall 123, a second space 140 is defined that also provides insulation for the viewing window 112. The second space 140 may also contain a gas, air, insulating material (such as insulating foam or other insulating material), or be at a vacuum similar to space 128 to facilitate the insulation.

FIG. 2H illustrates a cross-sectional view of a second exemplary insulated container 100 having a viewing window 112 along axis A-A illustrated in FIG. 2F in accordance with some embodiments. The viewing window 112 may be facilitated by aperture 129, the outer shell 135, and the inner shell 138. In some embodiments, either the outer shell 135 or the inner shell 138 may include a separate piece that is configured to fit within the aperture 129 to facilitate the viewing window 112. In this example, the separate piece may fit through the aperture 129 and be secured through press fit interfacing with side walls 126 or male/female fasteners, similar to viewing window 12 discussed above. This separate piece may provide support for the outer shell 135 so that a user does not puncture the outer shell 135. In certain embodiments, the container 100 includes only one of the transparent outer shell 135 or inner shell 138, as long as the arrangement is water-tight. Although the viewing window 112 is illustrated as being the substantially the same height as the insulated container 100, it will be appreciated that the insulated container 100 may be configured for a smaller viewing window 112 that does not extend the entire height of the insulated container 100. In alternative embodiments, multiple viewing windows may be provided at different heights.

As further illustrated by FIG. 2H, the inner wall 123 and outer wall 121 are coupled together forming side walls 126 (as best illustrated in FIG. 2A) such that space 128 is formed between them. In some embodiments, the inner wall 123 and the outer wall 121 extend around the majority of the insulated container 100 in a generally U-shape to provide an aperture 129 for the viewing window 112. As illustrated in FIG. 2H, the inner wall 123 and the outer wall 121 also extend down to and create bottom portion 118. However, in some embodiments, the bottom portion 118 may be formed separate from the rest of the insulated container 100. For example, the inner wall 123 and outer wall 121 coupling may end before the bottom portion 118 of the insulated container 100. This may allow the bottom portion 118 of the insulated container 100 to be formed of a different material and/or include a weighted portion. As an example, the bottom portion 118 of the insulated container 100 may be formed as a solid piece (e.g., of rubber, plastic, or other suitable material) to provide adequate weight to prevent the insulated container 100 from tipping over.

FIG. 21 illustrates a partial cross-sectional view of a second exemplary insulated container cap 125 along detail B illustrated in FIG. 2H in accordance with some embodiments. As discussed above, the insulated container 100 may also include threads 132 that are configured to couple to respective threads on a cap 125 in order to prevent spills and maintain temperature. In some embodiments, the cap 125 may include a seal 143 (e.g., an O-ring) to prevent leaks when the insulated container 100 is turned over or on its side. Although the seal 143 is illustrated as disposed within the cap 125, it will be appreciated that the seal 143 may be disposed around the threads 132 of the insulated cap 125.

FIG. 3 illustrates a front view of an exemplary insulated container 200 having a viewing window 212 with markers 215 in accordance with some embodiments. The insulated container 200 (e.g., insulated containers 10 and/or 100) may be double walled as discussed above and include a viewing window 212 (e.g., viewing window 12 or viewing window 112) that has defined markers 215 to indicate how much fluid is in the insulated container 200. For example, the markers 215 may include volume measurements (e.g., ounces (oz) or milliliters (mL)) for fluid held in the insulated container 200. In some embodiments, the volume measurements may range from 8 oz. to 128 oz. It will be appreciated that the markers 215 may not include volume measurements, but include other useful measurements such as time of day or motivating statements corresponding to each level. As an example, the markers 215 may include time of day measurements for when a user should reach the level in the insulated container 200 (e.g., 8 a.m., 12 p.m., 4 p.m., 8 p.m., etc.). It will be appreciated that for insulated container 100, the markers 215 may either be on the outer shell 135 or the inner shell 138.

It may be emphasized that the above-described embodiments, particularly any “preferred” embodiments, are merely possible examples of implementations, set forth for a clear understanding of the principles of the disclosure. Many variations and modifications may be made to the above-described embodiments of the disclosure without departing substantially from the spirit and principles of the disclosure. All such modifications and variations are intended to be included herein within the scope of this disclosure.

While this specification contains many specifics, these should not be construed as limitations on the scope of any disclosures, but rather as descriptions of features that may be specific to a particular embodiment. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments.

Although the invention has been described in terms of exemplary embodiments, it is not limited thereto. Rather, the appended claims should be construed broadly, to include other variants and embodiments of the invention, which may be made by those skilled in the art without departing from the scope and range of equivalents of the invention.

What is claimed is:

1. An insulated container comprising:
a top portion and a bottom portion;
an inner wall extending from the top portion to the bottom portion;
an outer wall extending from the top portion to the bottom portion, wherein the inner wall and the outer wall are coupled together and define a space between them, and wherein the inner wall and the outer wall define an aperture;
a viewing window disposed within the aperture; and
a cap coupled to the top portion.

2. The insulated container of claim 1, wherein the inner wall and the outer wall are formed or welded together.

3. The insulated container of claim 1, wherein the space between the inner wall and the outer wall is filled with one of a gas, air, or an insulating foam.

4. The insulated container of claim 1, wherein the space between the inner wall and the outer wall is at a vacuum.

5. The insulated container of claim 1, wherein the inner wall and the outer wall form a double-wall vacuum insulated metal container.

6. The insulated container of claim 5, wherein the inner wall and the outer wall are formed of stainless steel.

7. The insulated container of claim 1, wherein the viewing window comprises a plurality of markers.

8. An insulated container comprising:
a top portion and a bottom portion;
an inner wall extending from the top portion to the bottom portion;
an outer wall extending from the top portion to the bottom portion, wherein the inner wall and the outer wall are coupled together and define a space between them, and wherein the inner wall and the outer wall define an aperture;
a viewing window disposed within the aperture and coupled to the insulated container; and
a cap coupled to the top portion.

9. The insulated container of claim 8, wherein the inner wall and the outer wall are formed or welded together.

10. The insulated container of claim 8, wherein the space between the inner wall and the outer wall is filled with one of a gas, air, or an insulating foam.

11. The insulated container of claim 8, wherein the space between the inner wall and the outer wall is at a vacuum.

12. The insulated container of claim 8, wherein the inner wall and the outer wall form a double-wall vacuum insulated metal container.

13. The insulated container of claim 12, wherein the inner wall and the outer wall are formed of stainless steel.

14. The insulated container of claim 8, wherein the viewing window comprises a plurality of markers.

15. An insulated container comprising:
a top portion and a bottom portion;
an inner wall extending from the top portion to the bottom portion;
an outer wall extending from the top portion to the bottom portion, wherein the inner wall and the outer wall are coupled together and define a sealed space between them, and wherein the inner wall and the outer wall define an aperture;
an outer shell coupled to the outer wall;
an inner shell coupled to the inner wall, wherein a viewing window is formed through the outer shell, the aperture, and the inner shell; and
a cap coupled to the top portion.

16. The insulated container of claim 15, wherein the inner wall and the outer wall are formed or welded together.

17. The insulated container of claim 15, wherein the space between the inner wall and the outer wall is filled with one of a gas, air, or an insulating foam.

18. The insulated container of claim 15, wherein the space between the inner wall and the outer wall is at a vacuum.

19. The insulated container of claim 15, wherein the inner wall and the outer wall form a double-wall vacuum insulated metal container.

20. The insulated container of claim 19, wherein the inner wall and the outer wall are formed of stainless steel.
